(19) United States
(12) Patent Application Publication
(10) Pub. No.: US 2007/0095348 A1
(43) Pub. Date: May 3, 2007

(54) PARTICULATE BLOCKING OXYGEN DELIVERY MASK

(76) Inventors: Joseph Fisher, Toronto (CA); Hiroshi Sasano, Nagoya (JP); Nobuko Sasano, Nagoya (JP); Takafumi Azami, Nagoya (JP)

Correspondence Address: Vista IP Law Group LLP, 2040 MAIN STREET, 9TH FLOOR, IRVINE, CA, 92614, US

(21) Appl. No.: 11/461,291

(22) Filed: Jul. 31, 2006

Related U.S. Application Data
(60) Provisional application No. 60/728,086, filed on Oct. 19, 2005.

(51) Int. Cl. A62B 23/02

(52) U.S. Cl. 128/206.12; 128/207.11

(57) ABSTRACT

A particulate blocking oxygen delivery mask includes a face piece constructed at least partially of a filtering material, a securing member such as a strap attached to the face piece, and an gas entry port disposed on the face piece. The gas entry port may include an optional one-way valve. The mask may be coupled to a continuous flow of oxygen or may be used as a partial or non-rebreathing mask. The mask permits the administration of high concentrations of oxygen to the patient while at the same time isolating the patient from any potentially contagious airborne particles in their surroundings. It also isolates any potentially contagious droplets or aerosolized particulate matter exhaled by a patient from entering the environment and potentially infecting others.

### REFERENCE TO RELATED APPLICATIONS

This Application claims priority to U.S. Provisional Patent Application No. 60/728,086 filed on Oct. 19, 2005. U.S. Provisional Patent Application No. 60/728,086 is incorporated by reference as if set forth fully herein.

### FIELD OF THE INVENTION

The field of the invention generally relates to masks used for the administration of oxygen to a patient. More particularly, the field of the invention relates to oxygen masks that mitigate or eliminate entirely the dispersal of respiratory droplets or other particulate matter that contains an infectious agent such as, for example, virus or bacteria.

### BACKGROUND OF THE INVENTION

Many communicable diseases are transmitted via respiratory droplets or other aerosolized particles that are exhaled from an infected subject. For example, varicella, tuberculosis, and severe acute respiratory syndrome (SARS) are known to cause infections via nosocomial transmission. Other communicable diseases such as the highly pathogenic avian influenza (avian flu) are transmitted in a similar manner.

Patients that are infected with pathogens targeting the respiratory tract or shedding infectious particles into respiratory tract secretions frequently suffer from respiratory symptoms such as cough, and shortness of breath, and also have reduced oxygenation of the blood by the lungs. Consequently, supplemental oxygen must often be administered to these infected and potentially contagious patients. Most oxygen masks available on the market and in current use are made of gas impervious materials such as plastic or rubber and therefore have open ports through which microscopic and macroscopic droplets escape during coughing, talking or even exhalation, risking passing the infection to family and medical attendants.

With the commonly available oxygen masks, air is entrained from the environment with every breath as well, potentially exposing patients to infectious droplets, were they present in his or her vicinity. This is especially dangerous for patients that have compromised immune systems as such patients may be become severely ill if exposed to organisms that cause mild or no disease in otherwise healthy people. Examples of such patients are those at the extremes of age, those suffering from severe forms of illnesses such as diabetes, sepsis, autoimmune diseases, alcoholism, cancer, and those receiving immunosuppressive therapy or cancer chemotherapy such as patients with leukemia, lymphoma, solid tumors and transplant recipients. Most such patients would likely receive oxygen during the time they are the most ill and the most vulnerable to suffering severe illness from potentially pathogenic bacteria and viruses carried by visitors and their medical attendants. Thus, with most currently employed oxygen masks, the patient is not isolated from being infected by infectious respiratory droplets in his environment; nor is the environment protected from being contaminated by infectious droplets from the patient.

One oxygen mask, the Hi-Ox 80 mask, distributed by VIASYS HEALTHCARE, provides for patient isolation from the environment and protects the environment from contamination by the patient while administering oxygen. A separate filter element may be placed on the exhalation port of the Hi-Ox 80 mask to prevent exhalation of infected respiratory particles. On inhalation, the patient breathes either clean oxygen from a clean oxygen source or outside air that has passed through the filter.

The Hi-Ox 80 mask, however, is primarily intended for patients that need relatively high concentrations of oxygen. The Hi-Ox 80 mask uses a plastic face mask similar to standard oxygen masks but does not have holes for particulate matter to escape through as the patient exhales through valved tubes. In addition, the Hi-Ox 80 mask has a robust design which includes, among other things, multiple valves which necessarily increases the cost of the device. The three-valve design provides for complex sequential gas flows requiring considerable expertise for proper use and thus cannot be safely applied by non-trained personnel.

There is now a growing concern that a world-wide influenza pandemic (e.g., avian flu) may break out which may infect millions of persons in both developed and under-developed countries. Many if not most of those afflicted will come down with some form of respiratory distress. While supplemental oxygen may be administered to help maintain pulmonary function, conventional masks without filter capabilities may contribute to the spread of droplet-borne respiratory infection. See e.g., R. Somogyi et al., Dispersal of Respiratory Droplets With Open vs. Closed Delivery Masks: Implications for the Transmission of SARS, Chest 2004; 125; 1155-1157. While the Hi-Ox 80 mask may be utilized to a certain extent, there remains a need for a relatively low cost yet effective mask that can be used safely by paramedical and non-medical personnel to provide supplemental oxygen while at the same time protecting the care givers and other affected patients by isolating the patients and preventing the exhalation (and/or inhalation) of potentially or actually infected respiratory droplets or other particles that are suspended in the air.

Such as mask would be light weight and capable of being worn for an extended period of time. Moreover, such a mask should be easy to store and transport making it useful in the cases of major epidemic outbreaks. Similarly, there is a need for a mask that can be produced at a relatively low cost such that it can be delivered in large quantities. Finally, such a mask should be suitable for use by both paramedical (e.g., first responders) and non-medical personnel in case of mass disaster such as an epidemic. A mask of the type contemplated above may be used not only in the case of naturally occurring epidemics, but also in instances of bioterrorism.

### SUMMARY OF THE INVENTION

In one aspect of the invention, a particulate blocking oxygen delivery mask includes a face piece, at least part of which (or most of which) is constructed of a filtering material, a securing member such as a strap attached to the face piece, and a gas entry port disposed on the face piece. The gas entry port may have an oxygen entry port that can be connected to a source of oxygen.

The particulate blocking oxygen delivery mask may, in addition, include an optional one-way valve in the gas entry port or elsewhere on the face piece to allow air from the outside to enter therein during inhalation and prevent exhaled gases and particulate matter from leaving the mask except via flow through the particulate blocking material of the mask. This mask would be intended for use with a contagious patient receiving oxygen who is present in an environment where there is no risk to the patient from a virus or bacteria present in the air.

In one embodiment, the particulate blocking oxygen delivery mask may include an optional one-way valve disposed in the gas exhaust port or in the face piece that forces the patient to inhale outside air only through the filtering material and exhale directly to the environment for use with a patient requiring oxygen but otherwise not contagious, who requires isolation from potentially infectious particles in the environment.

In another embodiment, the particulate blocking oxygen delivery mask may include a gas entry port with an optional reservoir in which oxygen entering the gas entry port via the oxygen inlet port collects during exhalation. The gas entry port with reservoir may have an optional one-way valve in the gas entry port that is proximal (closest to the patient) to the oxygen entry port and oxygen reservoir. The one-way valve opens during inhalation allowing the entry of oxygen from the oxygen source and oxygen stored in the reservoir to the mask, and closes during exhalation allowing the oxygen from the oxygen inlet port to flow into the reservoir and limiting exhaled gas from entering the air inlet port.

In one embodiment, a particulate blocking oxygen delivery mask includes a face piece at least a portion of which is formed from a filtering material and a securing member such as a strap attached to the face piece. A two-piece gas entry port is disposed in the face piece, wherein the face piece is interposed between and outer piece and an inner piece. A one-way valve is disposed in the two-piece gas entry port. For example, the one-way valve substantially prevents exhaled gas from exiting the mask via the gas entry port.

In some embodiments, the mask may conform to the National Institute for Occupational Safety and Health (NIOSH) N-95 standard.

In another embodiment, a method of forming a particle blocking oxygen mask includes steps of providing a face piece constructed largely of a filtering material permeable to gases such as oxygen, nitrogen and carbon dioxide but substantially impermeable to microscopic droplets, bacteria and viruses, the face piece further including a securing member such as a head strap attached thereto. A two-piece gas entry port is also provided, wherein the first piece is provided on the inside of the face piece and the second piece is provided on the outside of the face piece. The first and second pieces of the gas entry port are mated to provide an gas entry port into an interior space of the face piece. The gas entry port may then be coupled to a source of oxygen. The gas entry port may contain an optional one-way valve and an optional oxygen reservoir.

In still another embodiment of the invention, a particulate blocking oxygen mask includes a face piece constructed at least in part from a filtering material. A securing member such as a strap is secured to the face piece. A two-piece gas entry port is secured in the face piece, the face piece being interposed between an outer piece and an inner piece of the two-piece gas entry port. The gas entry port includes a one-way valve disposed therein.

In another embodiment of the invention, a method of forming a particulate blocking mask includes providing a face piece constructed at least partially of a filtering material, the face piece further including a securing member such as a strap attached thereto. A two-piece gas entry port is provided that is formed from a mating inner piece and outer piece. A one-way valve is disposed on one of the inner piece and the outer piece. The gas entry port is mounted in the face piece by sandwiching the face piece between the mating inner piece and outer piece.

In another aspect of the invention, a method of forming a particulate blocking oxygen mask includes the steps of providing a face piece constructed at least partially of a filtering material, the face piece further including a securing member (e.g., strap) attached thereto. A two-piece gas entry port is provided, the two-piece gas entry port comprising a mating inner piece and an outer piece and a one-way valve disposed in one of the inner piece and the outer piece. The gas entry port is then mounted in the face piece by sandwiching the face piece between the mating inner piece and the outer piece.

In yet another aspect of the invention, a kit for modifying a particulate blocking mask includes providing a two-piece gas entry port, the two-piece gas entry port including a mating inner piece and outer piece and a one-way valve disposed in one of the inner piece and the outer piece. A crimping tool is provided for mounting the two-piece gas entry port to the mask. The crimping tool operates by sandwiching the face piece between the mating inner and outer pieces forming the gas entry port. The kit may also include flexible tubing and/or a gas reservoir bag.

In still another aspect of the invention, a method of forming a mask includes the steps of providing a face piece constructed at least partially of a filtering material, the face piece further including a securing member attached thereto. A gas entry port is provided that includes a flange portion. The gas entry port is mounted on the face piece by bonding the flange portion to a surface of the face piece.

In another aspect of the invention, a particulate blocking mask includes a face piece constructed at least partially of a filtering material. A securing member such as a strap is attached to the face piece. A gas entry port is secured to the face piece. A one-way valve may be disposed in the mask. For example, the gas entry port may include a one-way valve disposed therein.

### BRIEF DESCRIPTION OF THE DRAWINGS

FIG. 1A illustrates one embodiment of a particulate blocking oxygen delivery mask.

FIG. 1B illustrates another embodiment of a particulate blocking oxygen delivery mask.

FIG. 1C illustrates another embodiment of a particulate blocking oxygen delivery mask.

FIG. 1D illustrates another embodiment of a particulate blocking oxygen delivery mask.

FIG. 1E illustrates another embodiment of a particulate blocking oxygen delivery mask.

FIG. 2 illustrates another embodiment of a particulate blocking oxygen delivery mask.

FIG. 3 illustrates another embodiment of a particulate blocking oxygen delivery mask.

FIG. 4 illustrates a back side view of one piece of a two-piece gas entry port.

FIG. 5 illustrates a front side view of the one piece illustrated in FIG. 4.

FIG. 6 illustrates a perspective view of the assembled two-piece gas entry port.

FIG. 7A illustrates another perspective view of the assembled two-piece gas entry port.

FIG. 7B illustrates a cross-sectional view of the two-piece gas entry port illustrated in FIG. 7A.

FIG. 8 is graph of oxygen flow rate and FIO₂ as a function of time for a non-rebreathing mask 2 of the type shown in FIG. 3.

FIG. 9A is a perspective view of one side of the inner portion of a two-piece gas entry port.

FIG. 9B is a perspective view of the other side of the inner portion of the two-piece gas entry port shown in FIG. 9A.

FIG. 9C is a plan view of the inner portion of the two-piece gas entry port shown in FIG. 9A.

FIG. 9D is a plan view of the inner portion of the two-piece gas entry port shown in FIG. 9B.

FIG. 9E is a cross-sectional view of the inner portion of the two-piece gas entry port taken along the line A-A in FIG. 9D.

FIG. 9F is a cross-sectional view of the inner portion of the two-piece gas entry port taken along the line B-B in FIG. 9C.

FIG. 9G is a cross-sectional view of the inner portion of the two-piece gas entry port taken along the line C-C in FIG. 9C.

FIG. 9H is a side view of the inner portion of the two-piece gas entry.

FIG. 9I is a plan view of the inner portion of the two-piece gas entry port shown in FIG. 9D with the flexible valve member positioned thereon.

FIG. 10A is a perspective view of the outer portion of the two-piece gas entry port.

FIG. 10B is another perspective view of the outer portion of the two-piece gas entry port.

FIG. 10C is side view of the outer portion of the two-piece gas entry port.

FIG. 10D is a cross-sectional view of the outer portion of the two-piece gas entry port taken along the line A-A in FIG. 10C.

FIG. 10E is a cross-sectional view of the outer portion of the two-piece gas entry port taken along the line B-B in FIG. 10C.

FIG. 10F is another side view of the outer portion of the two-piece gas entry port.

FIG. 10G is another side view of the outer portion of the two-piece gas entry port.

FIG. 11 is a perspective view of a crimping tool according to one embodiment of the invention.

FIG. 12A illustrates a crimping tool being used to affix a two-piece gas entry port into a mask.

FIG. 12B illustrates another view of a crimping tool being used to affix a two-piece gas entry port into a mask.

### DETAILED DESCRIPTION OF THE PREFERRED EMBODIMENTS

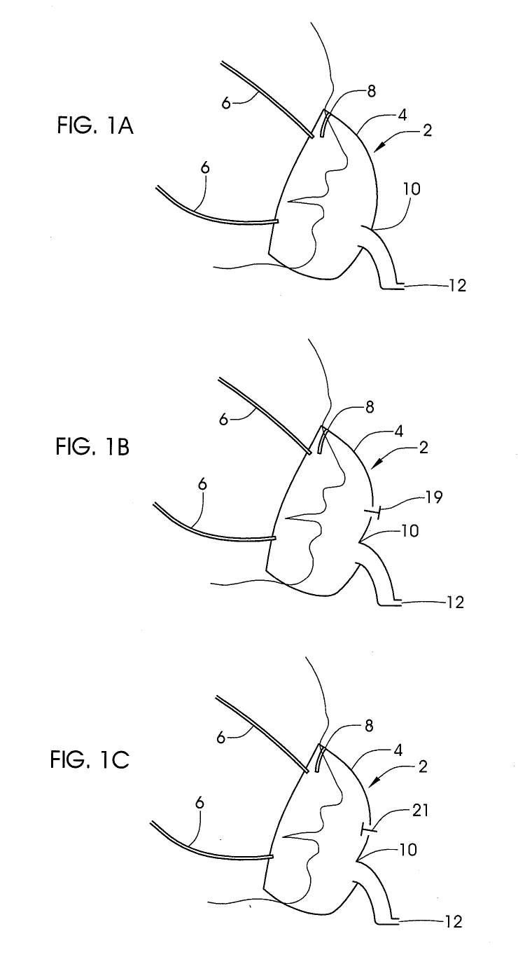

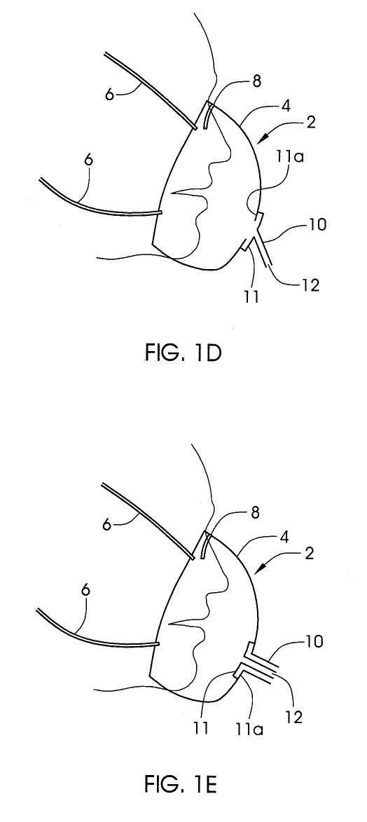

FIG. 1A illustrates one embodiment of a particulate blocking oxygen delivery mask 2. The mask 2 generally includes a face piece 4 that is at least partially formed from a filtering material having particulate blocking capabilities. In certain embodiments, substantially all of the face piece 4 is formed from the filtering material. However, in an alternative embodiment, only a small or minor portion of the face piece 4 is formed from a filtering material. For example, the face piece 4 may be formed in part from a plastic or other rigid material. The face piece 4 may have one or more regions within the larger mask 2 construction that is formed from filtering material.

The filtering material may comprise a fabric, cloth, or semi-flexible material porous to gases (e.g., air and carbon dioxide) and capable of substantially blocking the passage of particulate matter such as droplets, bacteria or viruses that are present in air or generated during patient breathing, talking or coughing. In patients that are infected with a respiratory-borne virus like SARS, varicella, or bacteria such as mycobacterium tuberculosis exhaled breath, the droplets of respiratory secretions in exhaled breath contain large numbers of infectious agents. These droplets and particles remain suspended in air for considerable periods of time and risk being inhaled by other patients, visitors or attendants, thereby transferring the infectious particles to these people. The filter material of the face piece 4 effectively blocks the transmission through the mask 2 of the droplets or infectious particles during patient exhalation and/or inhalation.

In one aspect of the invention, the filter material is chosen such that the mask 2 satisfies the National Institute for Occupational Safety and Health (NIOSH) N-95 standard. As one example, the face piece 4 may be formed using a particulate surgical mask available commercially from 3M of St. Paul, Minn. (e.g., Model Nos. 1870 and 9210). It should be understood, however, that use of the above-mentioned commercial 3M face piece 4 is provided as an example. Other particulate matter blocking face pieces 4 may also be used in accordance with the mask 2 described herein.

Still referring to FIG. 1A, the mask 2 includes one or more securing members 6 such as straps, which may be formed from an elastic material or the like, to affix the face piece 4 to the user's head. The mask 2 may also include an embedded or flexible strip 8 that permits customized fitting of the face piece 4 around the nose bridge of the user.

The mask 2 also includes a gas entry port 10 that may be formed integrally with the filter material of the face piece 4. The gas entry port 10 provides a means for oxygen ingress (and in some embodiments egress) through the mask 2. The gas entry port 10 may be formed as a multi-component (e.g., two) subunit that is secured to the pre-formed filter material of the face piece 4 (described in more detail below).

Alternatively, the gas entry port 10 may be formed as a single piece that is secured to the face piece 4 of the mask 2. For example, as shown in FIG. 1D, the gas entry port 10 is bonded or otherwise affixed to the external surface of the face piece 4. For example, the gas entry port 10 may include a flange portion 11 that includes a bonding surface 11 a that is affixed to the external surface of the face piece 4 through an adhesive or the like. Alternatively, as shown in FIG. 1E, the flange portion 11 may be positioned on the inside of the face piece 4. The bonding surface 11 a of the flange may then be affixed to an interior surface of the face piece 4 by the use of an adhesive or the like.

In the embodiment illustrated in FIG. 1A, the mask 2 operates as a simple or continuous flow mask 2. The gas entry port 10 is coupled through flexible tubing or the like (not shown) to a source of oxygen (not shown) via oxygen inlet port 12. The source of oxygen may include, for example, a pressurized oxygen containing gas cylinder or wall-mounted oxygen spigot or nipple (e.g., of the type found in hospitals and the like), or an oxygen concentrator. In this embodiment, a continuous or breath-synchronized pulsed flow of oxygen is provided to the interior of the face mask 4 via the gas entry port 10.

In one embodiment, shown in FIG. 1B, a one-way valve 19 allowing air to exit the mask 2 may be added to the mask 2 or gas entry port 10, so that the patient will have protection from infectious particles in the environment but the mask 2 will not protect the environment from droplets from the patient. This is useful for a patient that is receiving oxygen but is not contagious, but needs to be protected from a potentially infectious environment. The advantage of this valve 19 is that it bypasses the filter material during exhalation and thus reduces the resistance to flow of exhaled gas from the mask 2. Such a one-way valve 19 may be added to a number of the embodiments discussed herein.

In one embodiment, shown in FIG. 1C, a one-way valve 21 allowing air to enter the mask 2 may be added to the mask 2 or gas entry port 10. In such an embodiment, the patient will not have protection from droplets in the environment but the mask 2 will protect the environment (and those in it) from droplets exhaled from the patient. In this embodiment, the concentration of oxygen inspired may be reduced, but there will be little resistance to gas entering the mask if the patient's inspiratory rate exceeds the oxygen flow into the gas entry port 10. Such a one-way valve 21 may be added to a number of the embodiments discussed herein.

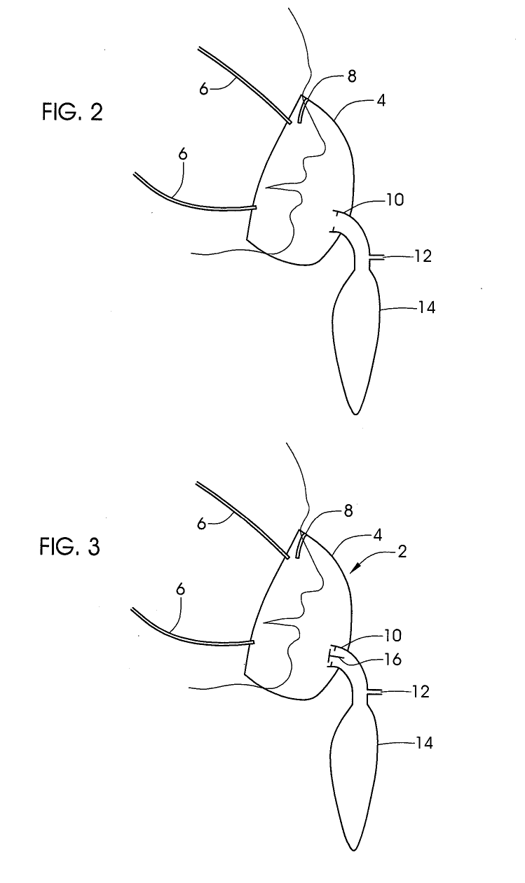

FIG. 2 illustrates an alternative embodiment of the mask 2. The mask 2 in FIG. 2 operates as a partial rebreathing mask 2. In this embodiment, an oxygen reservoir bag 14 is attached to the gas entry port 10 and is in continuity with the oxygen inlet port 12 The gas entry port 10 opens to the interior of the mask 2. Some exhaled gases from the patient may pass through the gas entry port 10 and into the oxygen reservoir bag 14, mixing with oxygen. In this embodiment, the patient, however, gets oxygen supplementation and is protected from inhaling any external particles or droplets. If the patient is infected, potentially infected droplets and particulate matter produced by the patient are contained within the interior of the mask 2 and/or oxygen reservoir bag 14 and associated tubing and connections.

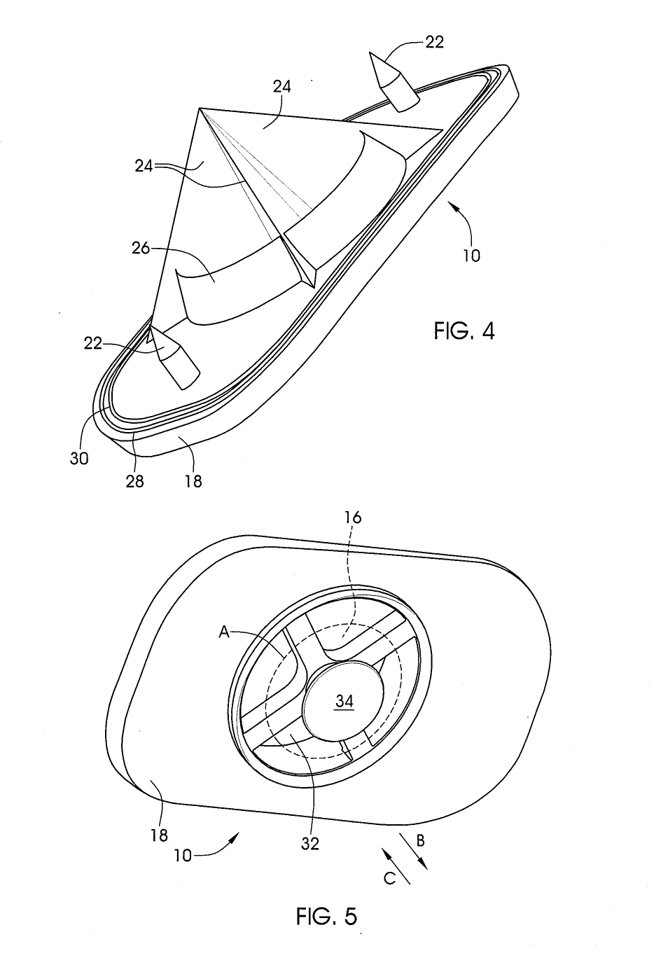

FIG. 3 illustrates yet anther embodiment of the mask 2. In this embodiment, a one-way valve 16 is provided proximal (toward the patient) aspect of gas entry port 10 and a reservoir 14 in continuity with the oxygen inlet port 12 of the gas entry port 10. The one-way valve 16 permits oxygen to pass into the interior of the face piece 4 during inhalation(and thus be inhaled) but prevents the passage of expired gases (and any droplets or aerosolized particles) into the gas entry port 10.

Thus all exhaled gas is forced through the particulate blocking material of the face piece 4. The patient inhales only clean oxygen from the oxygen reservoir 14 through the gas entry port 10 and, should the oxygen reservoir 14 be depleted, the balance of inspiration consists of air filtered through the face piece 4. Thus, the patient is isolated from the environment and the environment is isolated from the patient. In this regard, the mask 2 shown in FIG. 3 operates as a non-rebreathing mask 2.

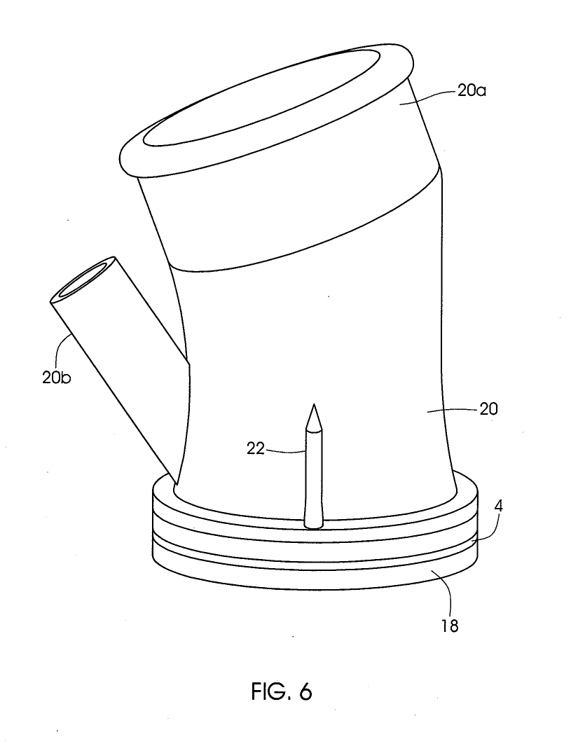

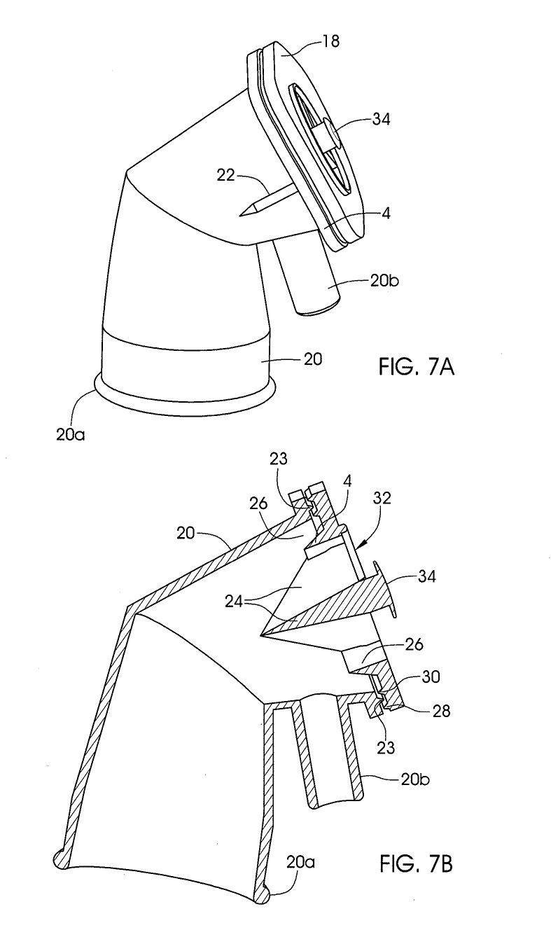

FIGS. 4, 5, 6, 7A, and 7B illustrate a two-piece construction of the gas entry port 10 according to one aspect of the invention. In this embodiment, the gas entry port 10 includes a interior piece 18 (best seen in FIGS. 4 and 5) and an exterior piece 20 (seen in FIGS. 6, 7A, and 7B). The exterior piece 20 may include a connector 20a for a gas reservoir bag 14 and a connector 20b for connection to a source of oxygen (e.g., oxygen inlet port 12). The gas entry port 10 is created in the face mask 4 when the interior and exterior pieces 18, 20 are brought together in a mating fashion (FIGS. 6, 7A, 7B). In one aspect, the gas entry port 10 is secured within the face piece 4 so as to form a substantially airtight seal between the periphery of the gas entry port 10 and the face piece 4. The gas entry port 10 may be mounted to the face piece 4 using a friction fit, an adhesive, or sandwiched on the outer and inner surfaces of the face piece 4.

As best seen in FIGS. 4, 6, and 7A, the interior piece 18 includes two alignment members 22. The alignment members 22 are sharpened at their tips to aid in penetrating the filter material of the face piece 4 during assembly. The exterior piece 20 (as shown in FIGS. 6 and 7A and 7B) includes corresponding holes (not shown) for receiving the ends of the alignment members 22. It should be understood, however, that there may be more than two alignment members 22. In addition, as an alternatively, the alignment members 22 may be positioned on the exterior piece 20 (not shown) with corresponding holes in the interior piece 18 (not shown).

The interior piece 18 further includes a plurality of cutting surfaces 24 or blades with are used to form the hole or passageway for the gas entry port 10. Located at the base of the cutting surfaces 24 are a plurality of deflecting members 26 that are used to deflect or push away the cut regions of the filter material of the face piece 4 of the mask 2. The interior piece 18 further includes one or more ridges 28, 30 around the periphery of the interior piece 18 that engage with corresponding mating surface 23 (e.g., detent, tab, troughs or valleys) in the exterior piece 20 to lock the interior and exterior pieces 18, 20 together.

Referring to FIG. 5, the interior piece 18 of the gas entry port 10 includes an opening 32 therein and a centrally mounted hub or knob 34. In the embodiment where the mask 2 utilizes a one-way valve 16, the valve 16 may be retained by the hub or knob 24. For example, the valve 16 may be made of a plastic or rubberized material with a central hole that is used to mount the valve within the exterior piece 20. FIG. 5 illustrates a dashed line A where the valve 16 would rest.

In operation, the valve 16 is able to move in the direction of arrow B to create an opening in the gas entry port 10 (e.g., during inspiration). The valve 16 forms a seal in the gas entry port 10 upon movement in the opposite direction (arrow C). The seal is formed inside the gas entry port 10 when the pressure inside the face mask 4 exceeds the pressure on the opposite side of the gas entry port 10 (e.g., during patient expiration or when a patient coughs or sneezes). In this regard, any droplet or other aerosolized particulate matter is retained in the interior of the face mask 4. In one aspect of the invention, the valve 16 forms a substantially airtight seal in the gas entry port 10.

With reference to the embodiment illustrated in FIG. 3, the mask 2 is placed on the face of a subject or patient. The straps 6 are then adjusted in angle and stretch to optimize the apposition of the mask 2 to the face to minimize any leak between the skin of the face and the mask 2. This may include bending or adjusting the flexible strip 8 over the nasal bridge. The source of oxygen is then connected to the gas entry port 10 via the oxygen inlet port 12 of the mask 2 with an oxygen reservoir bag 14. In one aspect of the invention, the source of oxygen is set to continuously provide oxygen into the oxygen inlet port 12. Of course, the source of oxygen may be set to provide an intermittent source of oxygen to the wearer.

Upon inhalation, the one-way valve 16 opens and oxygen from the reservoir bag 14 enters the mask 2. Some air may also be entrained through the filter material of the mask 2 depending on the pressure gradient between the inside and outside of the mask 2 and the resistance to air flow of the filter material. When the oxygen reservoir bag 14 collapses, the balance of inspiration is drawn through the filter material of the face piece 4.

The resistance for oxygen entry via the gas entry port 10 is generally lower than the resistance of air traversing the filter material of the mask 2. As a result, the oxygen is inhaled preferentially first, followed by ambient air. This provides a greater net inspired oxygen concentration than if there was no oxygen reservoir bag 14 and the oxygen entered the mask 2 continuously. The peak inspired oxygen concentration is limited by air entrained throughout inhalation. The flow of air through the mask 2 depends on the pressure gradient across the mask 2, but there will typically be some flow through the filter material of the face piece 4.

On exhalation, the exhaled gas passes through the filter material of the face piece 4. Because of the composition of the filter material, small droplets, viruses, or bacteria are prevented from escaping the interior of the face piece 4. In addition, the one-way valve 16 closes to substantially prevent exhaled gas from entering the oxygen reservoir bag 14.

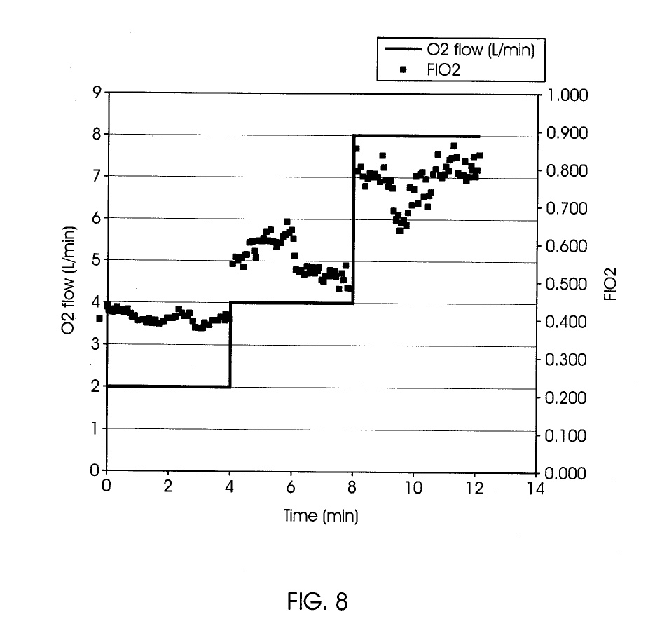

FIG. 8 illustrates a graph of oxygen flow rate and FIO₂ (fraction of O₂ in inspired air) as a function of time for a non-rebreathing mask 2 of the type shown in FIG. 3. The graph shows that the mask 2 shown in FIG. 3 with oxygen flows of 2 L/min and 4 L/min provides inspired oxygen concentrations expected from ordinary oxygen masks (providing no filtering protection) at a standard 8 L/min oxygen flow rate.

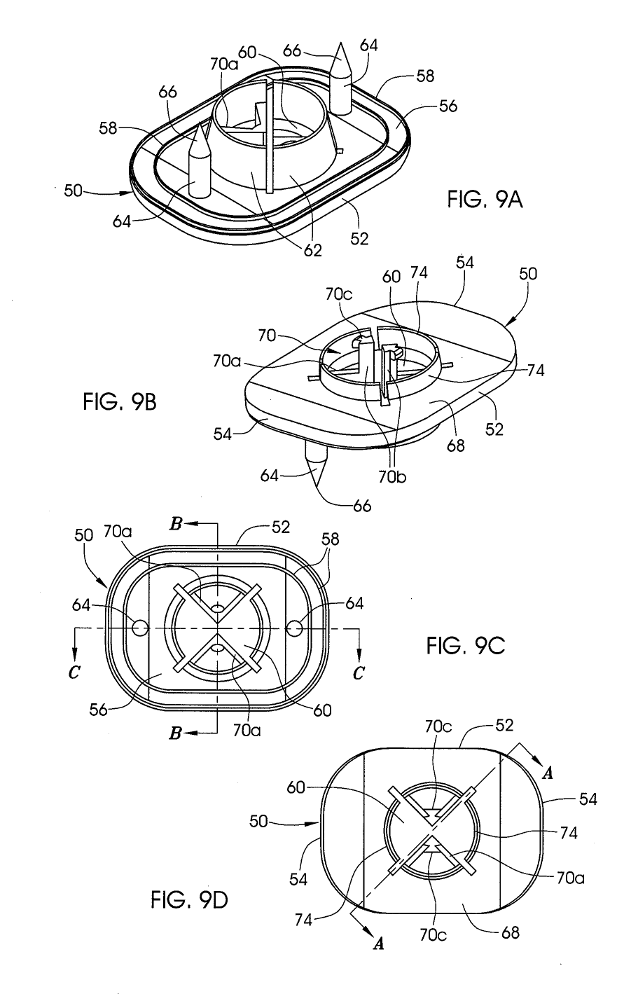

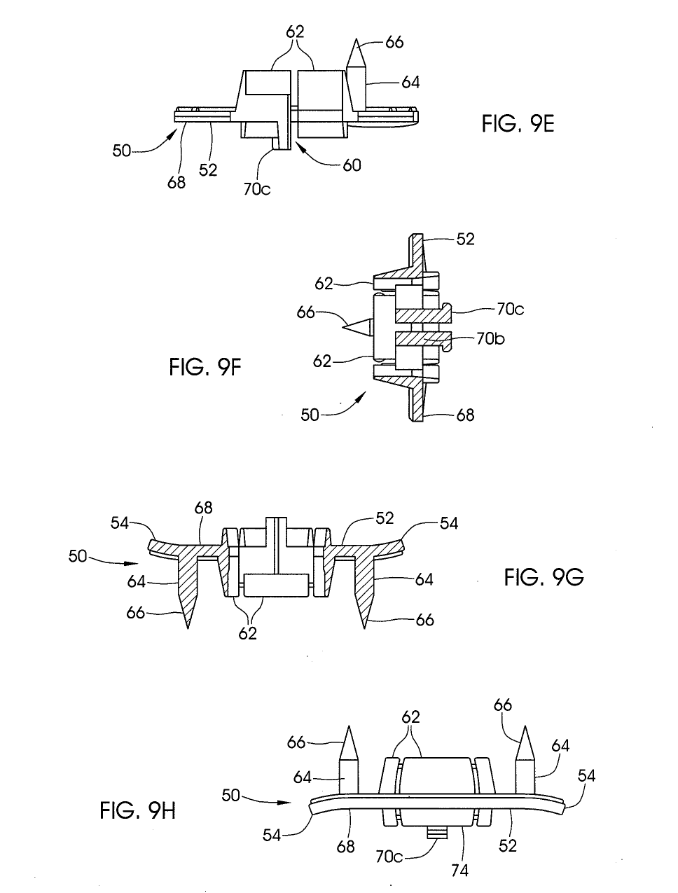

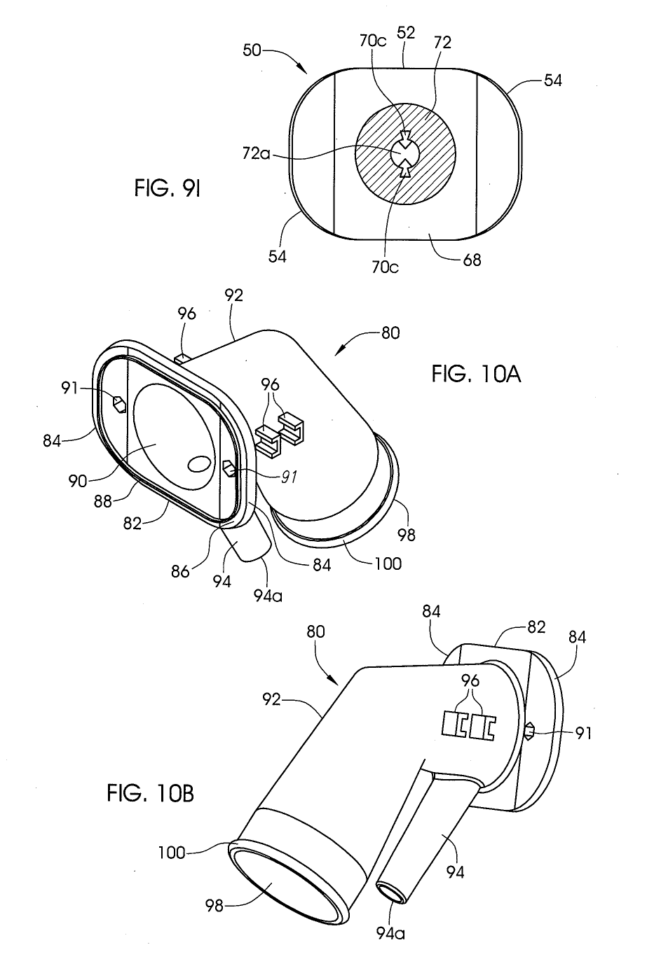

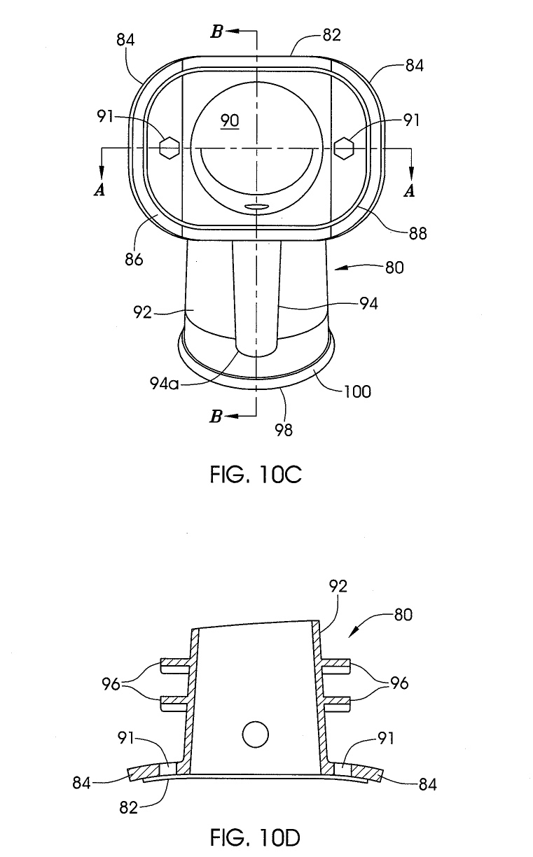

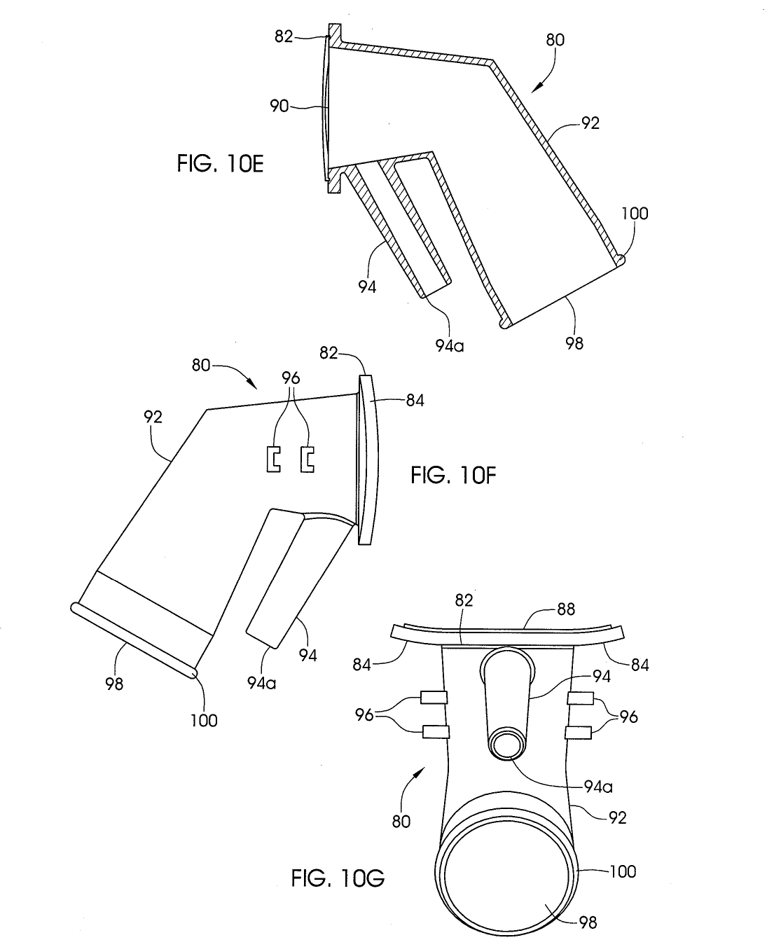

FIGS. 9A-9H and FIGS. 10A-10G illustrates another embodiment of a two-piece gas entry port 10. With reference to FIGS. 9A-9H, the two-piece gas entry port 10 includes a inner piece 50 that is affixed or otherwise disposed against an inner surface of the face piece 4 of the mask 2. The inner piece 50 is generally formed of a base 52. As best seen in FIGS. 9B, 9D, 9G, and 9H, the base 52 may include a pair of slightly angled edges 54. The angled edges 54 assist the inner piece 50 to conform to the arcuate nature of the inner surface of the face piece 4. The base 52 includes an inner surface 56 that may include one or more circumferential ridges 58 (best seen in FIGS. 9A, 9C). The ridges 58 may aid in forming a substantially airtight seal between the inner surface of the face piece 4 and the inner piece 50. The base 52 includes a central aperture 60 through which gas flows during operation of the mask 2.

As best seen in FIGS. 9A, 9E, 9F, 9G, 9H, a plurality of biasing members 62 are disposed about the aperture 60. The biasing members 62 are oriented generally perpendicular to the inner surface 56 of the inner piece 50. The biasing members 62 serve to maintain an open aperture 60 for gas flow. For example, where the face piece 4 is formed of a filter material, the biasing members 62 force or bias the filter material away from the aperture 60 that is formed in the face piece 4. In certain embodiments, the biasing members may be disposed on the outer piece instead of the inner piece. When one or more cutting members (described in more detail below) are used to form the opening or aperture 60 in the mask 2, the filter material remains, albeit in a cut state. The cut portions of the filter material of the face piece 4 are pushed outward by the biasing members 62.

As best seen in FIGS. 9A, 9B, 9C, 9E-9H, the inner piece 50 includes a plurality of alignment members 64 projecting generally perpendicular to the inner surface 56. The alignment members 64 may include sharpened tips 66 to aid in penetrating the face piece 4 of the mask 2 during assembly. Referring now to FIGS. 9B, 9D, and 9E-9H, the inner piece 50 includes an outer surface 68. A valve support member 70 is centrally disposed in the aperture 60 for supporting a flexible valve member 72 (shown in FIG. 91). The valve support member 70 is formed from a plurality of radially oriented ribs 70a that terminate near the center of the aperture 60 into support posts 70b. The support posts 70b are oriented generally perpendicular to the base 52. The support posts 70b include a retaining member 70c that is used to fixedly secure the flexible valve member 72. The retaining members 70c may be formed as a tab or projection. As best seen in FIGS. 9B, 9D, and 9H a valve seat 74 surrounds the aperture 60. The valve seat 74 may be formed, for example, from one or more raised projections. As best shown in FIG. 9B, the valve seat 74 may be formed from four such raised projections. The valve seat 74 typically has a flat or even profile such that the flexible valve member 72 is able to form a good seal with the valve seat 74.

FIG. 91 illustrates a flexible valve member 72 secured to the inner piece 50. The flexible valve member 72 includes an aperture 72a centrally disposed therein. The aperture 72a is dimensioned such that it is stretched or expanded to fit over the retaining members 70c on the support posts 70b. While the aperture 72a may permit some exhaled gases to pass through, the mask 2 and two-piece gas entry port 10 with the one-way valve 16 substantially prevents exhaled gases from passing therethrough. Moreover, in certain embodiments, the mask 2 may be coupled to a gas source that provides positive pressure through the mask 2 to prevent or mitigate the escape of exhaled gases.

With reference to FIGS. 10A-10G, the two-piece gas entry port 10 includes a outer piece 80 that is affixed or otherwise disposed against an outer surface of the face piece 4 of the mask 2. The outer piece 80 includes a base 82. As best seen in FIGS. 10A, 10B, 10D, 10F, and 10G, the base 82 may include a pair of slightly angled edges 84. The angled edges 84 assist the outer piece 80 to conform to the arcuate nature of the outer surface of the face piece 4. The base 82 includes an inner surface 86 that may include one or more circumferential ridges 88 (best seen in FIGS. 10A, 10C). The ridge 88 may aid in forming a substantially airtight seal between the outer surface of the face piece 4 and the outer piece 80. The base 82 includes a central aperture 90 through which gas flows during operation of the mask 2.

As best seen in FIGS. 10A, 10B, and 10C, the base 82 may include one or more holes 91 for receiving the alignment members 64 in the inner piece 50. The holes 91 may be dimensioned such that a friction fit is formed between the inner piece 50 and outer piece 80 after assembly. Alternatively, one or more tabs or detents on the alignment members 64 may be used to lock the inner piece 50 to the outer piece 80.

The base 82 of the outer piece 80 is coupled to a manifold 92. The manifold 92 may be formed as a tubular, elbow-shaped piece. As best seen in FIGS. 10A, 10B, 10C, 10E, 10F, 10G, the manifold 92 is coupled to an inlet port 94. The inlet port 94 is an elongate tubular structure having a lumen therein that communicates with the interior of the manifold 92. The inlet port 94 may be angled downward such that an end 94a of the inlet port 94 may be coupled to, for example, flexible tubing (not shown). In this regard, the inlet port 94 may be connected to a gas source, such as, an oxygen source (not shown). The gas source may supply a continuous or intermittent supply of gas (e.g., oxygen) to the patient.

As best seen in FIGS. 10A, 10B, 10D, 10G, one or more alignment tabs 96 are located on opposing sides of the manifold 92. The alignment tabs 96 are used during the assembly process described in more detail below to align the outer piece in a crimping tool 110 (described in more detail below). The alignment tab(s) 96 also serve as a safety feature to prevent the user from being pierced from the sharpened tips 66 of the alignment members 64.

As best seen in FIGS. 10A, 10B, 10C, 10E-G, the manifold 92 terminates in an opening 98. The opening 98 of the manifold 92 may include a circumferential rib 100 or lip that aids in securing a gas reservoir bag 14. The gas reservoir bag 14 may be secured to the opening 98 of the manifold 92 using a friction fit, for example, by stretching an opening on the gas reservoir bag 14 over the circumferential rib 100. An adhesive material such as tape (not shown) may also be used to affix the gas reservoir bag 14 to the manifold 92.

The masks 2 described herein permit the administration of high concentrations of oxygen to the patient while at the same time isolating the patient from any potentially contagious airborne particles in their surroundings. It also isolates any potentially contagious droplets or aerosolized particulate matter from entering the environment and potentially infecting others. In this regard, the mask 2 filters both inspired and exhaled gas of potentially infectious particulate matter. The masks 2 are an improvement over existing, standard N-95 masks because they permit the administration of oxygen at various concentrations while retaining all of the isolation properties of the N-95 mask.

In addition, the masks 2 have increased efficiency of oxygen delivery resulting from the sequential delivery of oxygen. The sequential delivery of oxygen, that is sequentially delivering oxygen then air, substantially increases the inspired oxygen concentrations compared to similar flows of oxygen by other masks. This is particularly important where oxygen is in short supply (e.g., field applications, during patient transport, mass casualties/infections) where oxygen is often the first “drug” to be used up.

In still another aspect of the invention, an adapter kit may be provided that adds oxygen-breathing functionality to a conventional particulate blocking mask 2. For instance, the adapter kit may include an interface for the mask 2. The interface may include the gas entry port 10, associated tubing, and optional reservoir bag 14. The gas entry port 10 is then mounted directly in the face piece 4 of a pre-existing mask 2. In one embodiment, the gas entry port 10 may include a one-wave valve 16 of the type disclosed herein. The gas entry port 10 may be single unit or a multi-component unit as is described above.

In this regard, the adapter kit may be delivered to hospitals or other agencies that have their own inventory of particulate blocking masks 2. The adapter kit would include instructions for use so that local hospital personnel could mount the gas entry port 10 and associated components to the mask 2 with relative ease. The particulate blocking mask 2 may include a mask that complies with the NIOSH N-95 standard. In a further aspect of the adapter kit, one-way valves 16, 19, 21 may be included as part of the kit and mounted to the mask 2.

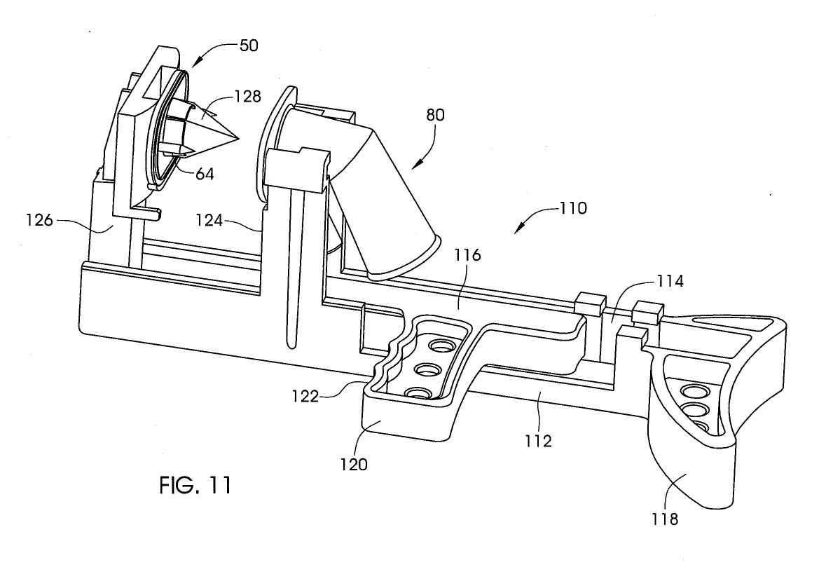

FIG. 11 illustrates a crimping tool 110 that is used to form the gas entry port 10 according to one aspect of the invention. The crimping tool 110 is described herein in connection with the assembly of a gas entry port 10 from a two-piece construction such as the inner piece 50 and outer piece 80 illustrated in FIGS. 9A-9I and FIGS. 10A-10G. The crimping tool 110 includes a housing 112 that has a recess 114 for receiving a moveable crimp element 116. The proximal end of the housing 112 includes a butt 118 that may be shaped to receive the thumb of a user. The moveable crimp element 116 includes a handle 120 affixed thereto. The handle 120 may include one or more recessed areas 122 to accommodate the fingers of a user.

Still referring to FIG. 11, the housing includes a mount 124 sized to received the outer piece 80 of the gas entry port 10. For example, the mount 124 may include one or more recesses to accommodate the alignment tabs 96 of the manifold 92. The mount 124 securely holds the outer piece 80 during the assembly of the two-piece gas entry port 10. The moveable crimp element 116 includes a mount 126 positioned at one end thereof. The moveable crimp element 116 fixedly secures the inner piece 50 during the assembly of the two-piece gas entry port 10. In the crimping tool 110 of FIG. 11, one or more blades 128 are secured to the mount 126. The one or more blades are generally oriented perpendicular to the mount 126 and pass through the aperture 60 in the inner piece 50.

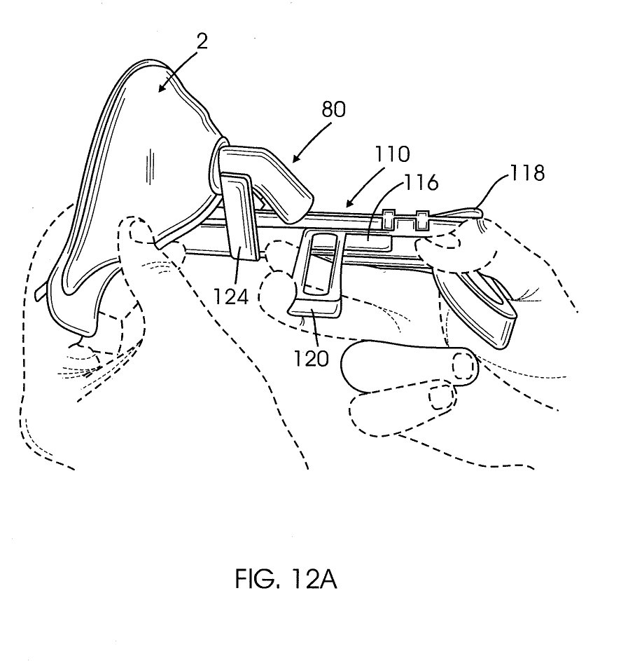

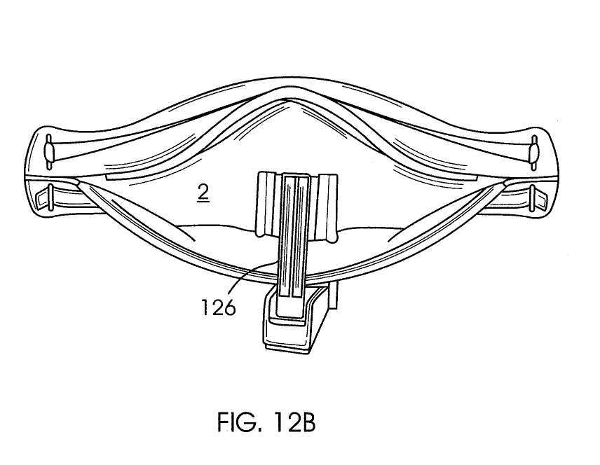

Referring to FIGS. 11 and 12A and 12B, during operation of the crimping tool 110, the mask 2 is placed between the two mounts 124, 126. The operator holds the crimping tool 110 in his or her hand, typically with the thumb on the butt 118 and the fingers on the handle 120. By closing the hands (in a gun like manner), the moveable crimp element 116 is brought closer towards the mount 124. The one or more blades 128 then pierce the material of the face piece 4 of the mask 2. In the embodiment shown in FIG. 11, four separate blades 128 are used to pierce the face piece 4 material. As the handle 120 is depressed further, the alignment members 64 of the inner piece 50 enter the corresponding holes 91 in the outer piece 80. The handle 120 is depressed further to sandwich the face piece 4 between the inner piece 50 and the outer piece 80. The two-piece gas entry port 10 is thus formed in the face piece 4 of the mask 2.

The crimping tool 110 of the type disclosed herein may be distributed as part of a kit. For example, the crimping tool 110 may be provided along with the components needed to form the two-piece gas entry port 10. The kit may also include tubing and/or a gas reservoir bag 14. The crimping tool 110 may be used to place a gas entry port 10 in any number of masks 2. For example, the kit may be utilized to place gas entry ports in different models of masks 2.

In an alternative embodiment, the inner piece 50 and the outer piece 80 may be connected to one another by the use of an adhesive. The adhesive may be used to bond portion(s) of the inner piece 50 and outer piece 80 directly to one another. Alternatively, the adhesive may be used to bond the respective inner and outer pieces 50, 80 directly to the face piece 4. In yet another alternative aspect, the inner piece 50 and outer piece 80 may be secured to one another (or the face piece 4) via a weld or the like.

In still another alternative aspect of the invention, the gas entry port 10 of the type disclosed in FIGS. 9A-9I, and 10A-10G may be integrated into a single piece construction. In this regard, the flexible valve member 72 or the like may be integrated into an outer piece 80. The outer piece 80, which may include a flange for mounting, may then be affixed directly to the external surface of the face piece 4. The outer piece 80 may be affixed or bonded to the face piece 4 using an adhesive, weld, or the like.

While embodiments of the present invention have been shown and described, various modifications may be made, particularly in the fabrication and attachment of the gas entry port, containing any or all, or any combination of gas entry port, oxygen inlet port, one-way valve, oxygen reservoir as discussed herein as well as additions such as devices to humidify inspired gas, nebulize medication, and other attachments known to those skilled in the art, without departing from the scope of the present invention. The invention, therefore, should not be limited, except to the following claims, and their equivalents.

What is claimed is:

1. A particulate blocking gas delivery mask comprising:
a face piece constructed at least partially of a filtering material;
a securing member attached to the face piece for securing the face piece to a user's face; and
a gas entry port disposed on the face piece.

2. The device of claim 1, wherein the gas entry port is secured to an exterior surface of the face piece.

3. The device of claim 1, the gas entry port including a flange portion that is mounted on the face piece.

4. The device of claim 1, further comprising a one-way valve disposed in the mask.

5. The device of claim 1, further comprising a one-way valve disposed in the gas entry port.

6. The device of claim 1, further comprising a gas reservoir bag coupled to the gas entry port.

7. The device of claim 1, wherein the filtering material satisfies the NIOSH N-95 standard.

8. The device of claim 5, wherein the one-way valve substantially prevents exhaled gas from passing through the gas entry port.

9. A particulate blocking oxygen delivery mask comprising:
a face piece constructed at least partially of a filtering material;
a securing member attached to the face piece; and
a gas entry port disposed on the face piece, the face piece being interposed between an outer piece and an inner piece of the gas entry port.

10. The device of claim 9, further comprising a one-way valve in the gas entry port.

11. The device of claim 9, wherein filtering material satisfies the NIOSH N-95 standard.

12. The device of claim 9, wherein the outer piece includes an inlet port.

13. The device of claim 9, wherein the outer piece includes a manifold sized to secure a gas reservoir bag.

14. The device of claim 13, further comprising a gas reservoir bag coupled to the manifold.

15. The device of claim 12, wherein the inlet port is coupled to a source of oxygen that provides a continuous flow of oxygen to the mask.

16. The device of claim 12, wherein the inlet port is coupled to a source of oxygen that provides an intermittent flow of oxygen to the mask.

17. The device of claim 10, wherein the one-way valve opens toward the inside of the mask.

18. The device of claim 10, wherein the one-way valve substantially prevents exhaled gas from passing through the gas entry port.

19. The device of claim 10, wherein the inner piece comprises:
a base having an aperture and a centrally disposed valve support member in the aperture;
a valve seat surrounding the aperture; and
a flexible valve member disposed on the valve support member.

20. The device of claim 19, wherein one of the inner and outer pieces comprise a plurality of biasing members for maintaining an opening in the face piece.

21. The device of claim 20, wherein one of the inner and outer pieces include two or more alignment members disposed about the aperture.

22. The device of claim 21, wherein the other of the inner and outer pieces includes corresponding holes dimensioned to receive the alignment members.

23. A method of forming a particulate blocking oxygen mask comprising the steps of:
providing a face piece constructed at least partially of a filtering material, the face piece further including a securing member attached thereto;
providing a gas entry port, the gas entry port comprising a mating inner piece and outer piece; and
mounting the gas entry port in the face piece by sandwiching the face piece between the mating inner piece and outer piece.

24. The method of claim 23, wherein a one-way valve is disposed in one of the inner piece and the outer piece.

25. The method of claim 23, wherein the step of mounting the gas entry port in the face piece is performed using a crimping tool.

26. The method of claim 25, wherein the crimping tool includes a plurality of cutting members to cut a passageway in the face piece.

27. The method of claim 23, wherein the mask satisfies the NIOSH N-95 standard.

28. The method of claim 24, wherein the one-way valve substantially prevents exhaled gas from passing through the gas entry port.

29. A kit for modifying a particulate blocking mask comprising:
providing a gas entry port, the gas entry port comprising a mating inner piece and outer piece;
providing a crimping tool; and
mounting the gas entry port to the mask using the crimping tool.

30. The kit according to claim 29, wherein the crimping tool comprises:
a housing including a mount for the outer piece;
a moveable crimp member slidably disposed in the housing, the moveable crimp element including a mount for the inner piece.

31. The kit according to claim 29, further comprising at least one of a gas reservoir bag and flexible tubing.

32. The kit according to claim 29, wherein a one-way valve is disposed in one of the inner piece and the outer piece.

33. A method of forming a mask comprising the steps of:
providing a face piece constructed at least partially of a filtering material, the face piece further including a securing member attached thereto;
providing a gas entry port, the gas entry port comprising a flange portion; and
mounting the gas entry port on the face piece by bonding the flange portion to a surface of the face piece.

34. The method of claim 33, wherein the flange portion is bonded to an exterior surface of the face piece.

35. The method of claim 33, wherein the flange portion is bonded to an interior surface of the face piece.
